(19) United States
(12) Patent Application Publication
(10) Pub. No.: US 2005/0235226 A1
(43) Pub. Date: Oct. 20, 2005

(54) Information browsing apparatus having communicating function

(76) Inventors: Jun-ichiro Watanabe, Tokyo (JP); Isshu Nakajima, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/932,091

(22) Filed: Sep. 2, 2004

(30) Foreign Application Priority Data
Dec. 1, 2003 (JP) 2003-401001

(51) Int. Cl. H04Q 7/20

(52) U.S. Cl. 715/835; 434/116

(57) ABSTRACT

An information browsing apparatus with a communicating function of the invention is constructed by a communicating unit connected to a network, a display unit, an input unit for receiving a user input, and an arithmetic operating unit. A function or information of a personal digital assistant is linked to an icon which is scrolled in a display screen. The function of the personal digital assistant, information on the Internet, or data in a data folder can be accessed simply by selecting the icon.

### INCORPORATION BY REFERENCE

The present application claims priority from Japanese application JP2003-401001 filed on Dec. 1, 2003, the content of which is hereby incorporated by reference into this application.

### BACKGROUND OF THE INVENTION

1. Field of the Invention

The invention relates to an interface of a cellular phone or another personal digital assistant.

2. Description of the Related Art

In recent years, since the IT infrastructure has been more and more equipped, a large amount of data can be communicated at a high speed by using cellular phones. Owing to the realization of advanced functions and multifunction of the cellular phones, the cellular phones having the functions of mail, a Web browser, a camera, and the like in addition to a speech function as an inherent function have been spread. In such a situation, the user uses the cellular phone not only as a simple communication apparatus for a speech but also as a mobile terminal for obtaining information and managing media data.

As a method of accessing many functions or information on the Internet by operating the cellular phone as mentioned above, there is a method of presenting each function as a layered menu to the user. For example, several items such as telephone, mail, Web browser, data folder, and the like can be selected on a first display screen (hereinafter, referred to as a top menu) of the cellular phone and the user selects one of them. Subsequently, the user further selects one of small items from the selected item. For example, when the user selects the mail, he selects either E-mail or communication between terminals, or in the case of the Web browser, the user selects a desired one of a mode for inputting a URL which has been registered in the terminal before, a mode for newly inputting a URL, a mode for searching for the URL, and the like.

However, while the realization of the multifunction of the cellular phone has been progressed and an amount of information that is accessed by the user is increasing, a layer of the layered menu structure becomes deep and the complicated operation of a few steps is necessary for the user to execute a target function. Therefore, it takes a time to access the function or information or it is difficult to access the information in a real-time manner. This is mainly because since a size of display screen of the cellular phone is small, an amount of information that can be displayed in a lump onto the display screen is small and the access is executed only by the button operation. Such low operability causes a case where all of the functions cannot be fully used or a case where the valuable information cannot be obtained.

### SUMMARY OF THE INVENTION

It is an object of the invention to provide an interface which can solve the above problems and improve operability of a cellular phone and enables an access to a function or information to be easily executed.

To accomplish the above object, according to the invention, functions or information of a personal digital assistant are/is displayed as images (hereinafter, referred to as icons) which symbolize them onto a display screen of the personal digital assistant and they are sequentially displayed onto the display screen by scrolling a plurality of icons.

A cursor to select the icon is displayed in a predetermined position in the display screen. When the cursor is focused on the icon, the color of the cursor changes, thereby notifying the user that this icon can be selected. A character string (hereinafter, referred to as a caption) showing the contents of the icon is displayed near the icon.

When the user selects the icon focused by the cursor, he can access the function or information linked to the icon.

According to the invention, since a plurality of functions or information are displayed as icons which are scrolled in the display screen to the user, the user can easily access the function or information simply by selecting a target icon.

By using the interface of the invention, since a change in information is displayed on the display screen as a change in icon, the user can recognize the change in information in a real-time manner.

By the interface of the invention, many functions of the personal digital assistant can be used by the simple operation. Since anybody can easily access a great amount of information, the user can also effectively obtain unexpected valuable information.

### BRIEF DESCRIPTION OF THE DRAWINGS

FIG. 1 is an explanatory diagram showing an outline of a system according to the invention;

FIG. 2 is an explanatory diagram showing one display screen in the invention;

FIG. 3 is an explanatory diagram showing a change in icon upon updating of information in the invention;

FIG. 4 is an explanatory diagram showing a change in caption upon updating of the information in the invention;

FIG. 5 is an explanatory diagram showing a change in display screen upon updating of the information in the invention;

FIG. 6 is an explanatory diagram showing a display screen for obtaining detailed information upon selection of the icon in the invention;

FIG. 7 is an explanatory diagram showing a message display in the invention;

FIG. 8 is an explanatory diagram showing a display screen of a submenu in the invention;

FIG. 9 is an explanatory diagram showing a display screen of a list of registered icons in the invention;

FIG. 10 is an explanatory diagram showing a display screen for registration of an icon in the invention;

FIG. 11 is an explanatory diagram showing a display screen for deletion of the icon in the invention;

FIG. 12 is an explanatory diagram showing a display screen for registration of a state in the invention;

FIG. 13 is an explanatory diagram showing a 3-dimensional display screen in the invention; and

FIG. 14 is an explanatory diagram showing a 4-split display screen in the invention.

### DETAILED DESCRIPTION OF THE EMBODIMENT

An embodiment of the invention will now be described hereinbelow with reference to the drawings.

In the following explanation of the embodiment, “personal digital assistant” denotes a portable apparatus such as cellular phone, PDA, or the like; “icon” indicates an image representing a function or information of the personal digital assistant; “cursor” shows a mark for selecting one of a plurality of icons shown in the display screen; and “click” indicates an input which is selected when the cursor is focused on the icon.

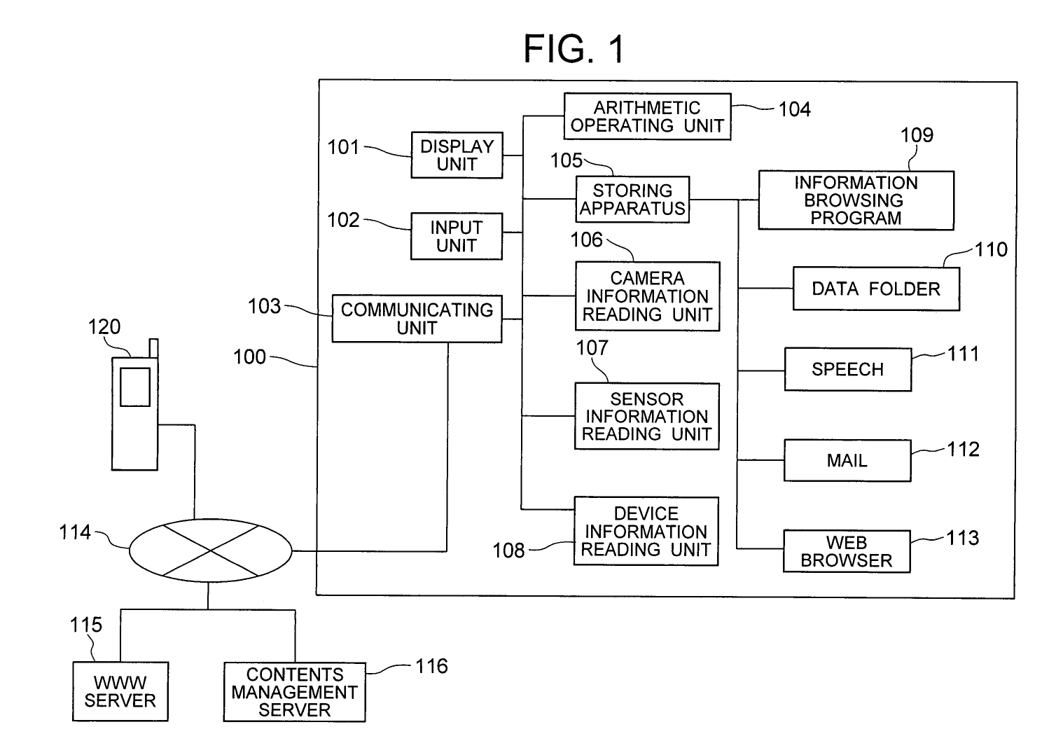

FIG. 1 is a schematic constructional diagram showing an embodiment of the invention. Reference numerals 100 and 120 denote personal digital assistants. For example, the personal digital assistant 100 comprises: a display unit 101; an input unit 102; a communicating unit 103; an arithmetic operating unit 104; a storing apparatus 105; a camera information reading unit 106; a various-sensor information reading unit 107; a device information reading unit 108; an information browsing program 109; a data folder 110; a speech unit 111 having a function for a speech; a mail function 112; and a Web browser 113. The personal digital assistants 100 and 120 are connected to a WWW server 115 and a contents management server 116 through an Internet network 114. In order to distribute contents, the contents management server 116 comprises: a storing unit for accumulating the contents; a control unit for controlling distribution of the contents; and a communicating unit which is connected to the Internet network and transmits and receives data. The server 116 stores user information into the storing unit as necessary. The user information includes registration setting of services which are requested by the user, group information of the personal digital assistants which exchange information, and the like.

In FIG. 1, it is assumed that in addition to the communicating function as an inherent function of the cellular phone, the interface of the invention handles obtainment of information which is provided from mail, a Web browser, a WWW server, or a contents server, management of image data of objects photographed by a camera, obtainment of information from various sensors, and the like.

The information browsing program 109 has been stored in the storing apparatus 105. When the arithmetic operating unit 104 activates the information browsing program 109, the data stored in the speech unit 111, the mail 112, the Web browser 113, and the data folder 110 and the information which is provided from the WWW server 115 and the contents management server 116 are displayed as icons onto the display screen.

The functions of the personal digital assistant are linked to the icons. Although the functions of the personal digital assistant are assumed to be the speech unit 111, mail 112, Web browser 113, camera 106, and sensor 107, other functions provided for the personal digital assistant can be also linked.

Contents which can be obtained via the Internet are also linked to the icons. Although the contents which can be obtained via the Internet are the information which is provided from the WWW server 115 and the contents management server 116 here, other information that can be obtained through the Internet can be also obtained.

Contents which are communicated between the personal digital assistants without passing through the server can be also linked to the icons. For example, the information of the personal digital assistant 120 is linked to the icons of the personal digital assistant 100, thereby enabling the user of the personal digital assistant 100 to grasp a state of the personal digital assistant 120. In this case, the information which is communicated between the personal digital assistants is a state (free, under working, during school hours, etc.) of a friend in the communication with him or device information which can be obtained by the personal digital assistant. However, it can be other information. The setting for linking the information of the personal digital assistant 120 to the icons of the personal digital assistant 100 and the setting of the contents which are linked are made by a request from the personal digital assistant 100, a permission from the personal digital assistant 120, or the like. The personal digital assistants in which the user information is mutually exchanged can be also registered as a group.

The state information of the user can be inputted explicitly by the user of the personal digital assistant or can be a user state which is presumed on the basis of the device information. The information which can be obtained by the personal digital assistant here denotes: mode (for example, manner mode or silent mode) information of the personal digital assistant; information showing whether or not the personal digital assistant is being charged; and device information showing an open/closed state of the personal digital assistant in the case of a closable type personal digital assistant, a field intensity, a residual amount of a battery, on/off of a power source, and the like. However, other information can be also obtained. The user state can be also presumed by other information, for example, an elapsed time from the timing when the personal digital assistant is operated last, time, position information and movement information of the personal digital assistant which are obtained by a GPS or another means, and the like. The information of the personal digital assistant 120 which is linked to the icons of the personal digital assistant 100 can be also formed by the contents management server 116 in place of the personal digital assistant 120.

Information stored in an external memory can be linked to the icons.

Broadcasting can be also linked to the icons. The “broadcasting” denotes television broadcasting, terrestrial digital broadcasting, radio broadcasting, or the like.

The icon is converted into an array of a character string which denotes the contents of the icon and displayed by, for example, the button operation. The opposite operation for converting the array of the character string which shows the contents of the information into an icon showing the same contents and displaying by, for example, the button operation can be also executed.

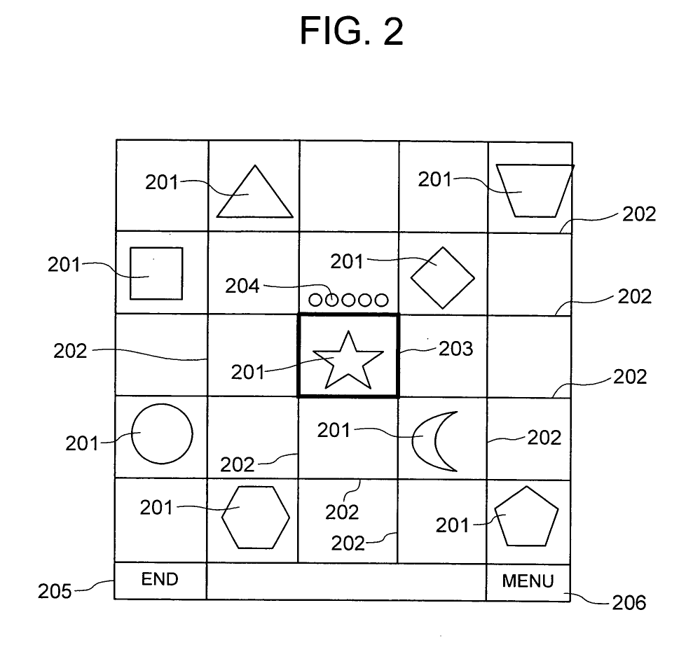

FIG. 2 shows a display screen in the invention. A plurality of icons 201 displayed in FIG. 2 are scrolled in the display screen together with grids 202. The “scroll” denotes that, for example, a part or all of an area in a virtual space where the icons are arranged in predetermined positions is set to a range which is displayed on the display screen, starting positions and angles when the range and virtual space which are displayed on the display screen are displayed and the like are changed, and the display positions of the icons change with the elapse of time. By scrolling, a number of icons larger than the number of icons which can be displayed into the display screen at a time can be sequentially displayed.

The scrolling operation similar to that of the icon is not executed to a cursor 203 but the cursor 203 is displayed in a predetermined position of the display screen. Although the predetermined position is set to the center of the display screen here, it can be set to another position. The display position can be also changed by the button operation or the like.

When the cursor 203 is focused on the icon 201, a color of the cursor 203 changes or a color or a size of the icon 201 changes, flickers, or the like, so that the cursor 203 or the icon 201 is emphasis-displayed, thereby enabling the user to confirm that it is in a focusing state. The focusing state is a state where display positions of the icon and the cursor coincide or they are close to each other. In the focusing state, a caption 204 showing the contents of the icon 201 can be also displayed near the icon 201. By clicking the icon in the focusing state, the user can select the focused icon and activate the application linked to the icon.

By displaying the cursor to the predetermined position and scrolling the icon as mentioned above, the user can select the cursor by executing only the operation to click the button when the icon overlaps the cursor and is focused. Such a user interface has the following advantages. Since the user does not need to move the cursor, input means for moving the cursor is unnecessary, a structure of the terminal apparatus can be simplified, and the operation to select the icon is simplified for the user. In the personal digital assistant whose display screen is small, the scroll can be easily controlled in such a manner that the icon which is scrolled passes through the position where it overlaps the cursor without moving the cursor. Since the icon is automatically (or semiautomatically) scrolled, the user can passively receive the information which is provided. A range where the icons are displayed onto the display screen at a time is set to only a part of the virtual space where the icons have been arranged and different areas in the virtual space are sequentially set to a display range, so that the number of icons which are displayed at a time is limited. The icons can be easily seen and while the user watches the display screen, many icons can be sequentially displayed. This is an information presenting method which is effective, particularly, in the personal digital assistant whose display screen is relatively small.

An “end” button 205 and a “menu” button 206 are displayed on the display screen. The user executes the operation associated with the “end” display 205 in the input unit 102, thereby finishing the application. By executing the operation associated with the input unit 102, the user can select the “menu” 206 and select a plurality of submenus associated with the “menu”. Although the “end” 205 and the “menu” 206 are displayed here, another expression can be also used.

The scrolling direction of the icon 201 can be set to a predetermined direction or changed at random. The scrolling speed can be set to a predetermined speed or changed at random. When the scrolling direction is the lateral direction, by scrolling the icon so that the cursor is moved to a position along a lateral column of the grids, or when the scrolling direction is the longitudinal direction, by scrolling the icon so that the cursor is moved to a position along a longitudinal column of the grids, the cursor can be easily focused on the icon. Further, as for the scroll, both the scroll in the case where the user does not operate or the scroll by the user's operation are possible. As for the motion of the icon in the case where the user does not operate, for example, after the icon is scrolled for a predetermined time, the icon stops at the cursor position for a predetermined time. By clicking this icon, the user can obtain detailed information by the activation or the like of the application linked to the icon. If the user does not click, the icon restarts to scroll after the elapse of the predetermined time. The scrolling direction can be also changed when the icon restarts to scroll. It is desirable to certainly stop the icon at the cursor position when the scroll is stopped.

As for the motion of the icon by the user operation, the icon moves while the user continues to click the button for the operation. The moving speed can be set to a predetermined speed or changed (for example, accelerated). When the user does not continuously click the button but clicks the button for a short time (for example, 0.5 second) and subsequently releases it, the closest icon or the closest icon which is moving toward the cursor position stops so as to be located at the cursor position. It is also possible to allow the personal digital assistant to have the input unit which can designate the direction information and scroll the icon in the direction designated by the user input.

As a method of moving the icon 201, it can be also scrolled on the basis of a certain rule. As for the rule, it is possible to use a desired one of a rule in which when the application is reactivated, the icon which was accessed last before a power source is turned off is displayed at the center of the display screen, a rule in which information showing a frequency of access to the icon is managed by the server and a frequency in which the icon is displayed on the display screen is increased or decreased in accordance with the access frequency, a rule in which related icons are displayed near the target icon, and the like.

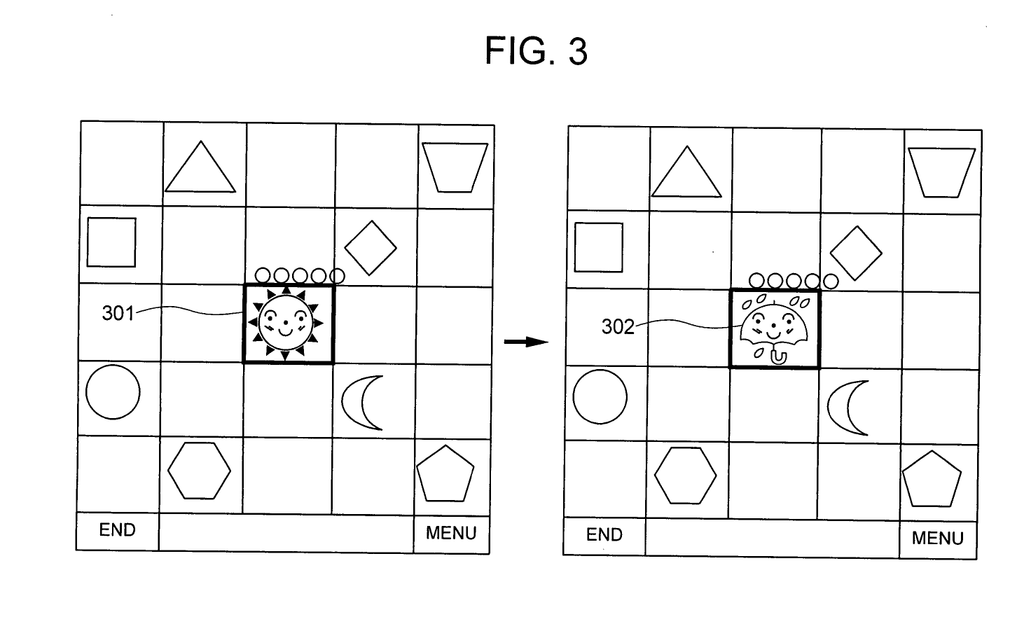

As shown in FIG. 3, when there is a change in information linked to the icon, the icon display is changed from an icon 301 before the information change to an icon 302 after the information change and the user is notified of the change in information. For example, in the case of the icon linked to a weather forecast service which is provided by the contents management server 116, when the weather forecast is changed from “fair” to “rain”, the icon to be displayed is changed from a pattern of a sun to a pattern of an umbrella, or the like.

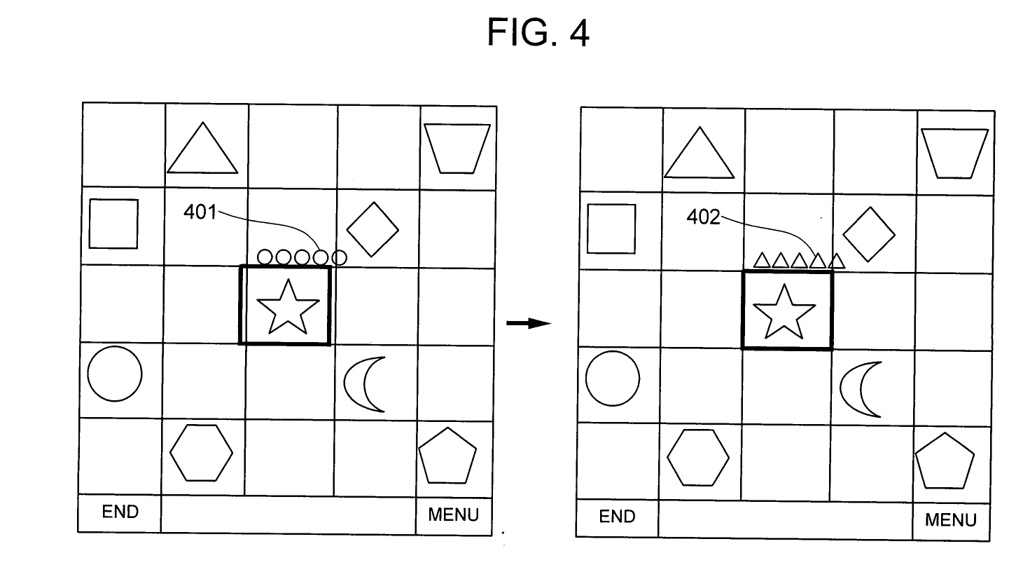

As shown in FIG. 4, it is possible to change the caption from a caption 401 before the information change to a caption 402 after the information change and notify the user of the change in information.

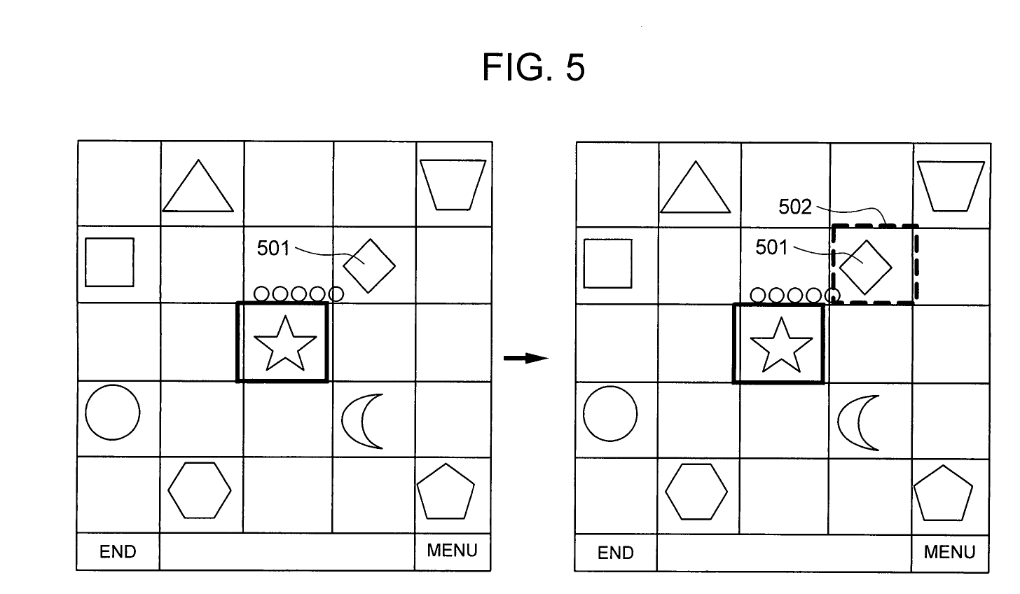

As shown in FIG. 5, it is also possible to display a mark 502 showing the information change to a position around an icon 501 before the information change and notify the user of the change in information. It is also possible to use another method whereby a flickering frame 502 is displayed around the icon 501, the icon itself flickers, the user is notified by a sound, or the like.

The speech unit 111 can make a call when the user selects the icon linked to the speech function by operating the input unit 102, or a call can be also made to a specific partner by a method whereby telephone numbers are preliminarily linked to the icons and the user selects a desired icon.

According to the mail function 112, when the user selects the icon linked to the mail function by operating the input unit 102, the mail application is activated, a mail sending destination is selected from a list of sending destinations stored in the storing apparatus 105, and mail can be transmitted. By forming icons in each of which a sending destination of mail, a title of the mail, and a main sentence of the mail have previously been designated and selecting a desired one of the icons, the mail of the specific title and specific contents can be sent to the specific partner. The sending destination, the title of the mail, and the main sentence of the mail can be also independently designated or some of them can be also designated.

The Web browser 113 is activated when the user selects the icon linked to the Web browser by the input unit 102. The Web browser obtains the contents from the WWW server 115 by using the Internet network 114. By designating an existing location of a specific URL or contents to the icon, the specific contents can be also obtained by clicking the icon.

By operating the input unit 102, the user can communicate with the contents management server 116 and obtain the contents by using the communicating unit 103 or communicate with another mobile terminal. An application of a personal digital assistant of another person can be also activated by using the inter-terminal communication.

It is possible that the user operates a camera by the input unit 102, image data obtained by photographing an object by the camera is recorded by the storing apparatus 105, and a data file stored in the data folder 110 is displayed as an icon onto the display screen.

Information obtained by the sensors 107 is also stored in the storing apparatus 105. The information which can be obtained by the sensors is now assumed to be information which can be obtained by the sensors regarding a position, an acceleration, a tilt angle, and a terrestrial magnetism. However, information which can be obtained by other sensors can be also used.

The state of the personal digital assistant (hereinbelow, referred to as device information) obtained by the device information reading unit 108 can be stored in the storing apparatus. The device information is assumed to be information showing a field intensity, a residual amount of the battery, whether or not the device is being charged, an open/closing state of the closable type personal digital assistant, communications charges, and on/off of the power source. However, other information can be also stored.

When the field intensity is weak or the battery residual amount is small, communication is made with another predetermined personal digital assistant from the communicating unit 103 and a message 701 such as “The battery residual amount of the terminal A is small” or the like is displayed on a display screen of this another personal digital assistant, or the state of the user can be also notified by using another means by changing the icon 201, changing the caption 204, or the like. It is also possible that in a base station connected to the network, it is detected that the user has turned off the power source of the personal digital assistant or the field intensity is weak, and such another personal digital assistant is notified of detection information. It is assumed that the other personal digital assistant as an information notifying destination of each personal digital assistant has previously been stored in the contents management server or the like.

When the communications charges exceed a predetermined amount, a message to notify the user that the communication charges are too high is displayed (701) on the display screen of the personal digital assistant, or a state of the charges can be also notified by using another means by changing the icon 201, adding a new icon, changing the caption 204, or the like.

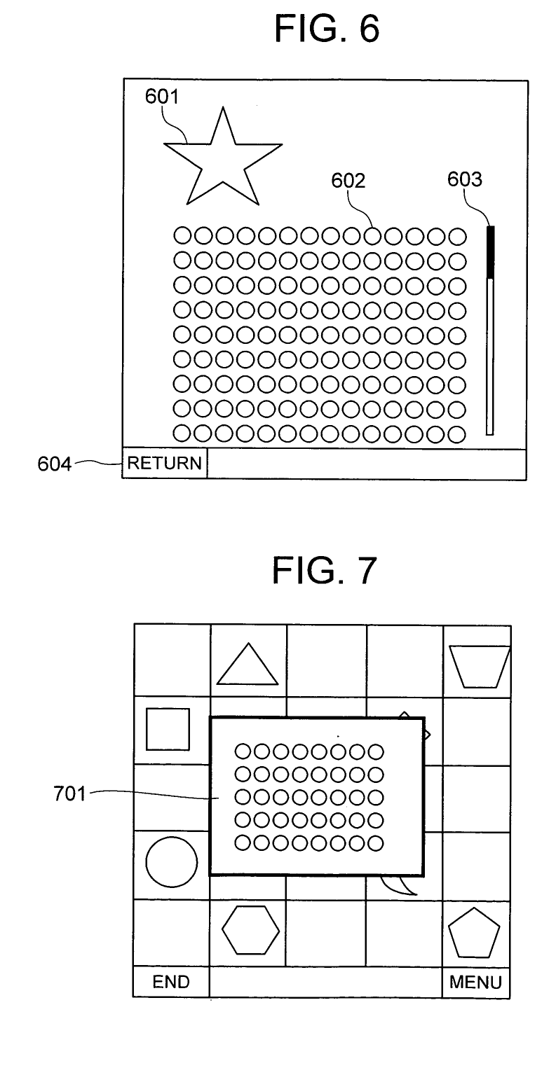

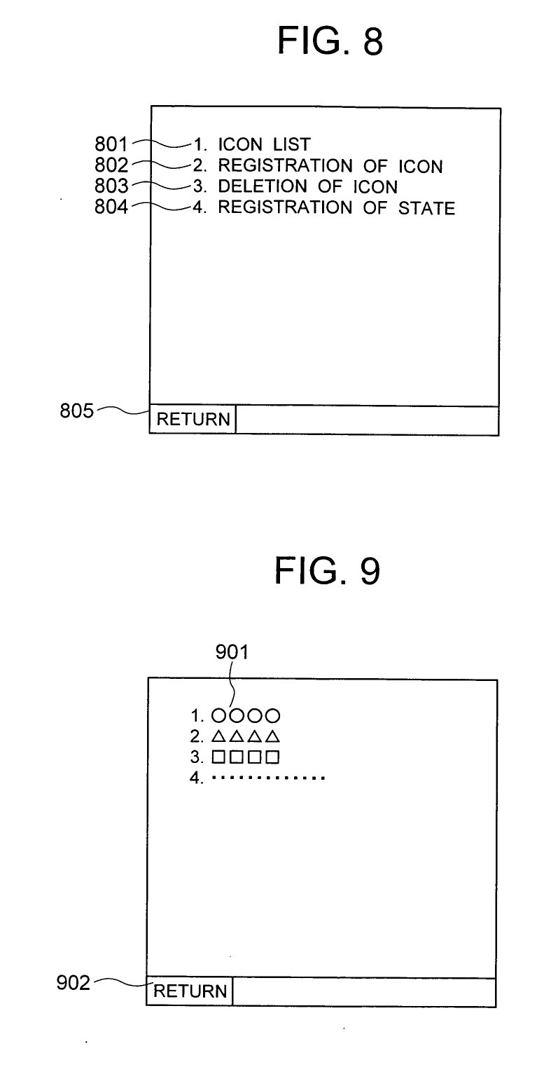

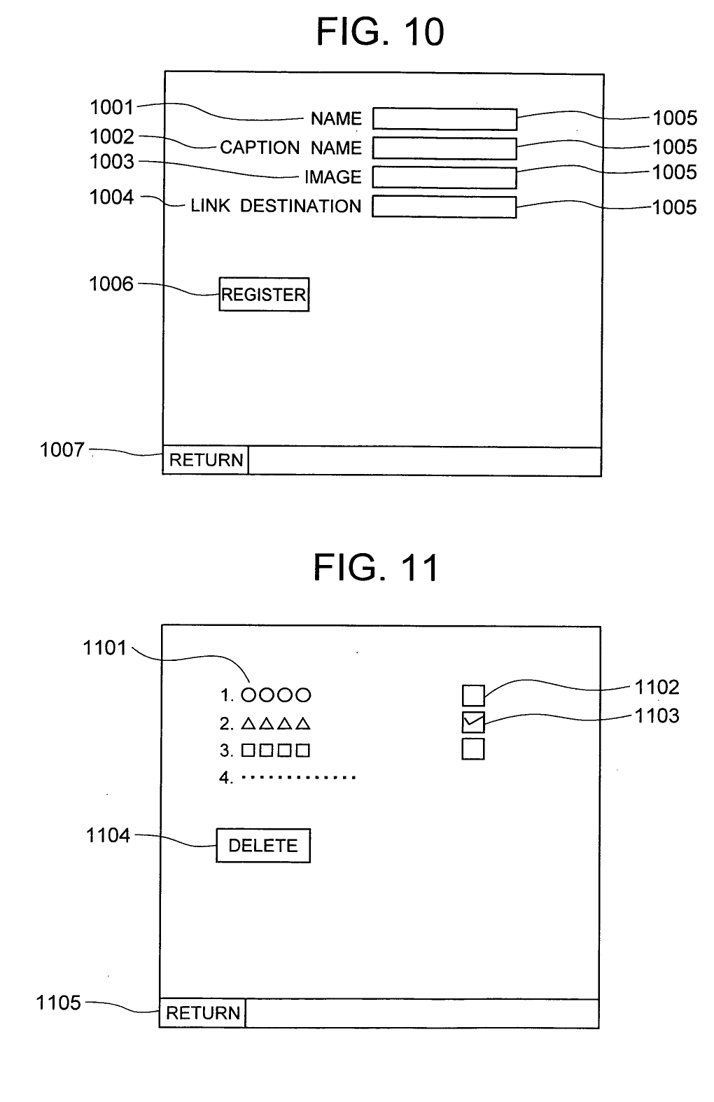

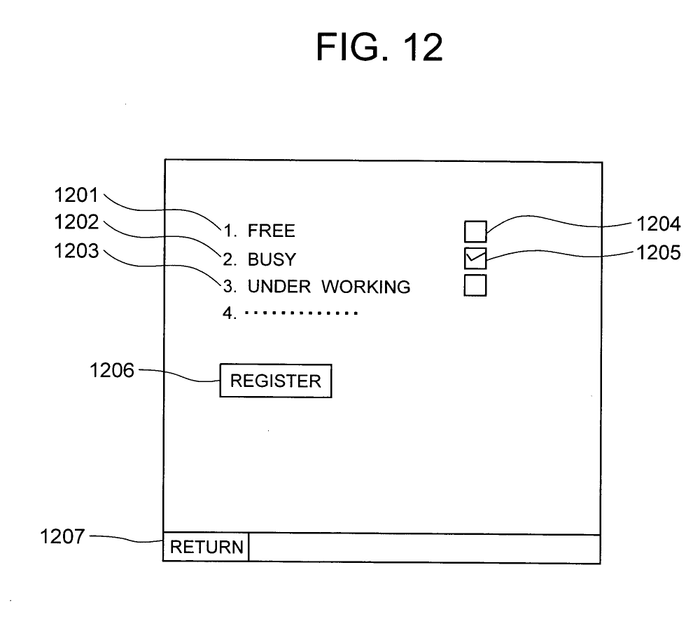

FIG. 6 is an explanatory diagram showing a display screen for displaying detailed information. When the icon 201 focused by the cursor 203 is selected by operating the input unit 102, the detailed information can be obtained.

As detailed information, either one or both of an image 601 representing the information and a detailed explanatory sentence 602 of the information is/are displayed. If the detailed explanatory sentence 602 cannot be displayed in the display screen, a scroll bar 603 is displayed, thereby enabling the scroll. A “return” button 604 is displayed at a lower left position of the display screen. When the operation associated with “return” is executed by operating the input unit 102, a main display screen (FIG. 2) is displayed. An expression other than “return” can be also used.

When the “menu” 206 is selected in the main display screen (FIG. 2), a list of submenus is displayed. Although the submenus are assumed to be an “icon list” 801, a “registration of icon” 802, a “deletion of icon” 803, and a “registration of state” 804, other submenus can be also displayed. When the operation associated with a “return” 805 at the lower left position of the submenu display screen is executed by operating the input unit 102, the main display screen can be displayed.

When the “icon list” 801 is selected from the submenus, a list of functions and information displayed as icons on the display screen is displayed (901). When the operation associated with a “return” 902 at the lower left position of the submenu display screen is executed by operating the input unit 102, the submenu display screen can be displayed.

When the “registration of icon” 802 is selected from the submenus, a display screen to execute registration for displaying a new icon onto the display screen is displayed. This display screen is used to input items such as “name” 1001 of the function or information which is displayed as an icon, “caption name” 1002 which is displayed on the display screen, “image name” 1003 which is used as an icon, and “link destination” 1004 of the icon. Those items are inputted into an area 1005 for inputting each item. Other items showing user's attributes can be also used. By selecting a “register” button 1006 after they are inputted, a new icon is displayed onto the display screen.

As functions linked to the icons, services which are provided by the contents management server or the like can be also designated. For example, a list of the services which are provided such as a notifying service of current affairs news or hit song information and the like are obtained from the contents management server and desired information notifying service is enabled to be registered as a function which is linked to the icon that is displayed. The fact that the notifying service has been registered is notified to the contents management server together with ID information of the personal digital assistant and registered. When new information is generated in the registered notifying service, the contents management server transmits the information or a notification showing that the information has been generated to the registered personal digital assistant. If there is an incoming of a part or all of the updated information or a notification showing that the information has been updated, the personal digital assistant notifies the user of the incoming by using, for example, the method as shown in FIGS. 3 to 5. It is also possible that display control information for changing the icon display or a new icon is transmitted from the contents management server and the icons which are displayed by the terminal apparatus are controlled by using those information. The user can browse the detailed information by clicking the icon corresponding to the notifying service. In the case where only the notification showing that the information has been generated is transmitted first, when the click is inputted, the personal digital assistant accesses the address in which the information of the notifying service has been accumulated, thereby obtaining the information. It is also possible that when new information is generated, the contents management server transmits it together with the icon (a pattern showing a kind of news, a photograph of an artist, or the like) according to such information and displays it onto the display screen of the personal digital assistant. As mentioned above, by designating the kind of interested information, the user can receive the presentation of the information which is selected by a service provider.

When the “deletion of icon” 803 is selected from the submenus, a display screen to execute the operation for deleting the icons which the user does not want to display is displayed on the display screen. On this display screen, a list of registered icons (1101), a check area 1102, and a “delete” button 1104 are displayed. When a check mark 1103 is inputted to the check area 1102 of the icon to be deleted and the “delete” button 1104 is clicked, this icon is deleted. The icon to be deleted can be also selected by the cursor in place of the check area.

When the “registration of state” 804 is selected from the submenus, a display screen to execute the operation for registering a state of the user of the personal digital assistant is displayed. His “own state” is assumed to be “free”, “busy”, and “under working”. However, other states can be also set. On this display screen, items such as “free” 1201, “busy” 1202, and “under working” 1203, a check area 1204, and a “register” button 1206 are displayed. When a check mark 1205 is inputted into the check area 1204 to be registered and the “register” button 1206 is selected, the registered state is transmitted from the communicating unit 103 to a personal digital assistant of another user. A desired button can be selected by the cursor in place of the check area. It is also possible to enable an input for allowing a specific one of the states of the various devices to correspond to a user's states, for example, a manner mode in a terminal to a user's busy states. By this setting, when the device information indicates the specific state, it is presumed that the terminal is in the corresponding user state. A notification or the like of this state to another personal digital assistant is executed.

The icons to be displayed and set information showing whether or not the state of a local office is notified (displayed) to another terminal, whether or not the state information of another office is linked to the icon of the local office, and the like can be stored into the storing apparatus 105 of each terminal or held in another apparatus such as a contents management server or the like connected to the Internet network.

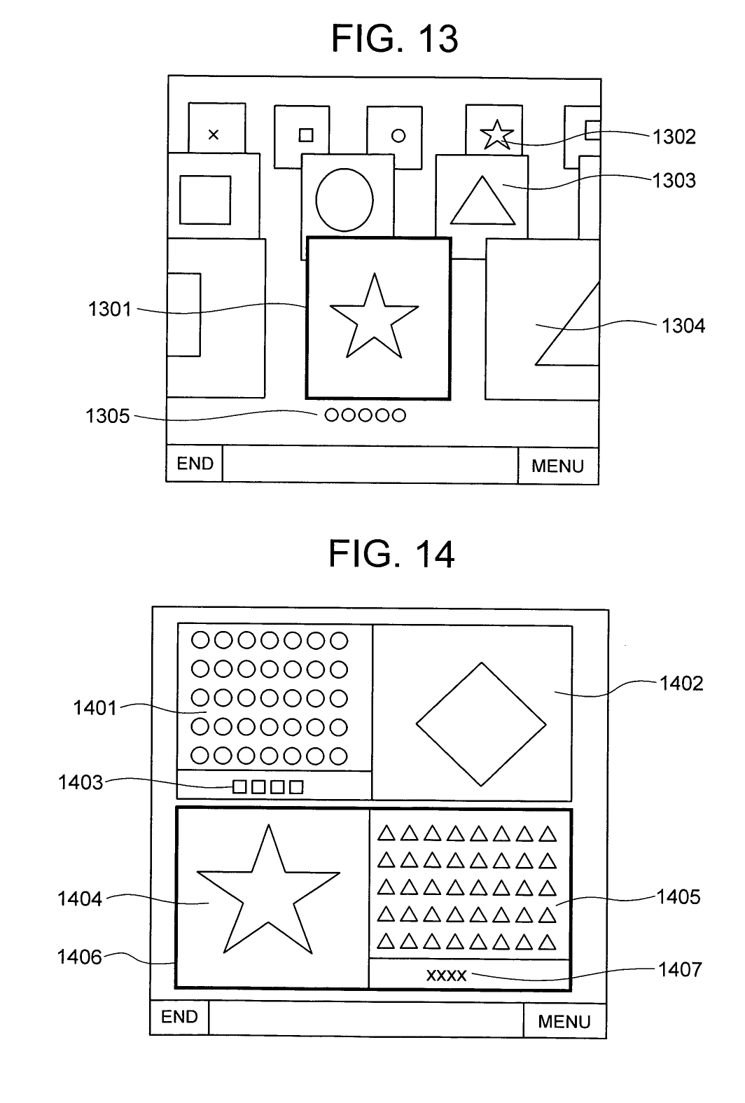

Variations of the display screen of the invention will now be described. FIG. 13 is a display screen showing a space in 3-dimensional depth. A cursor 1301 is displayed at the center of the display screen. Icons are displayed to three columns of “back” 1302, “center” 1303, and “front” 1304. However, the number of columns can be increased or decreased to a value which is larger or smaller than 3. A caption 1305 showing contents of the icon selected by the cursor 1301 is displayed near the icon. The icon is moved to the right and left and backward and forward by the user operation from the input unit 102.

FIG. 14 is an explanatory diagram of a 4-split display screen. On this display screen, a cursor 1406 selects an upper half or lower half of the display screen by the user operation. An icon 1402 is displayed in the half portion of an area which is not selected by the cursor and a sentence 1401 for explaining the contents of the icon and a caption 1403 are displayed in the residual half portion. An icon 1404 is displayed in the half portion of an area selected by the cursor and a character (string) 1405 for explaining the contents of the icon and a caption 1407 are displayed in the residual half portion. The character (string) 1405 in the area selected by the cursor are scrolled. The icon, character (string), and caption in the area which is not selected by the cursor are updated every predetermined time.

It should be further understood by those skilled in the art that although the foregoing description has been made on embodiments of the invention, the invention is not limited thereto and various changes and modifications may be made without departing from the spirit of the invention and the scope of the appended claims.

1. A terminal apparatus connected to a network, comprising:
a communicating unit for communicating with said network;
a display unit;
an input unit for receiving a user input; and
an arithmetic operating unit for controlling said communicating unit and said display unit and executing an arithmetic operation,
wherein said display unit displays a display screen including a plurality of icons associated with an object which is processed by said arithmetic operating unit while scrolling said display screen and displays a cursor at a predetermined position, and
when said cursor is focused on one of said plurality of icons, if a selection input to select said one of the icons is received in said input unit, said arithmetic operating unit accesses the object associated with said selected icon.

2. An apparatus according to claim 1, wherein the object associated with said icon is an application which is executed by said arithmetic operating unit or data and is an object which is held in a storing apparatus held in said terminal apparatus or in a server or another user terminal to which said terminal apparatus can be connected through said network.

3. An apparatus according to claim 2, wherein when the object associated with said icon is the object which is held in said another user terminal which can be connected through said network, said icon is displayed in said terminal apparatus in the case where said another user terminal permits the display of said icon.

4. An apparatus according to claim 2, wherein the object associated with said icon is an object regarding said another user terminal which can be connected through said network and said object regarding said another user terminal includes a battery state in said another user terminal, its position information, or incoming information from said another user terminal.

5. An apparatus according to claim 1, wherein said input unit has an input device for designating a direction and a scrolling direction of said display screen is controlled on the basis of the direction which is inputted by using said input device.

6. An apparatus according to claim 1, wherein a scrolling direction of said display screen is set at random.

7. An apparatus according to claim 1, wherein when a scrolling direction of said display screen is changed, said display unit stops said display screen and displays it for a predetermined time and said stop position is a position where said cursor is focused on one of said icons.

8. An apparatus according to claim 1, wherein a scrolling speed of said display screen is controlled on the basis of the input from said input unit.

9. An apparatus according to claim 1, wherein when said cursor is focused on one of said icons or when one of said icons is selected, said display unit additionally writes a predetermined character string corresponding to said icon to said focused icon or said selected icon.

10. An apparatus according to claim 2, wherein said display unit changes the display of said icon in accordance with a change in state of the application associated with said icon or a change in data.

11. An apparatus according to claim 1, wherein the icons to be displayed on said display unit are set individually or according to their types based on the input from said input unit.

12. An apparatus according to claim 11, wherein when the icons displayed on said display unit are set individually or according to their types, said communicating unit notifies a contents server which can be connected through said network of type information of said set icon, and the icon which is formed by said setting is associated with data that is selected in accordance with the type information of said icon and transmitted by said contents server.

13. An apparatus according to claim 1, wherein from a contents server which can be accessed via said network, a list of information services which are provided by said contents server is received, said contents server is notified of the information service which is selected from said list by using said input unit, and the icon which is associated with said information service is formed.

14. An apparatus according to claim 13, wherein said display unit changes a display state of the icon associated with said information service in accordance with a notification showing updating of information of said information service which is transmitted from said contents server or incoming of a part of or all of the updated information.

15. A service providing method of providing information services to terminal apparatuses connected to a network by using a server connected to said network, wherein
each of said terminal apparatuses comprises a communicating unit for communicating with said network, a display unit, an input unit for receiving a user input, and an arithmetic operating unit for controlling said communicating unit and said display unit and executing an arithmetic operation, and in said display unit, icons associated with the information services which are supplied from a server apparatus that can be accessed via said network are displayed while scrolling the icons, and information of the information service associated with the icon selected by using a cursor that is displayed in a predetermined position is displayed,
in said server, designation information to designate the information service that is required by said terminal apparatus is received, said required service is registered in correspondence to said terminal apparatus, and an icon corresponding to said required service is displayed to the display unit of said terminal apparatus, and
when new service information is generated in the information services which are provided by said server, the terminal apparatus which requests said information service is searched, an information generation notification for notifying said terminal apparatus of the generation of said new service information or at least a part of said newly generated service information is transmitted to said terminal apparatus, and in said terminal apparatus, when the icon corresponding to said information service is selected, the information which is provided by said information service is displayed to said display unit.

16. A method according to claim 15, wherein when said information generation notification or at least a part of said generated service information is transmitted from said server to said terminal apparatus, icon display control information or icon information which is used to change an icon display state of said display unit of said terminal apparatus is also transmitted.

17. A method according to claim 15, wherein
when the new service information is generated in the information services which are provided by said server, in the case where the information generation notification for notifying said terminal apparatus of the generation of said new service information or a part of said newly generated service information is transmitted to said terminal apparatus,
in said terminal apparatus, when a notification showing that the icon corresponding to said information service has been selected is received, all of said new service information or a portion of the service information which is not sent is transmitted to said terminal apparatus.

18. An inter-terminal information exchanging method of exchanging information among a plurality of terminal apparatuses connected through a network, wherein
a first terminal apparatus comprises a communicating unit for communicating with said network, a display unit, an input unit for receiving a user input, and an arithmetic operating unit for controlling said communicating unit and said display unit and executing an arithmetic operation, and in said display unit, a plurality of icons including an icon associated with a second terminal apparatus are displayed while scrolling the icons, and one of icons is selected by using a cursor that is displayed in a predetermined position in accordance with the input from said input unit, and
when the icon associated with the second terminal apparatus is selected in said first terminal apparatus, said first terminal apparatus accesses said second terminal apparatus, holds information regarding said second terminal apparatus, or accesses a server apparatus connected to said network or a storing apparatus of said first terminal apparatus.

19. A method according to claim 18, wherein said first terminal apparatus receives presentation of terminal state information of said second terminal apparatus and the display of the icon associated with said second terminal apparatus is controlled in accordance with the terminal state information of said second terminal apparatus.

20. A method according to claim 19, wherein said terminal state information of said second terminal apparatus is provided to said first terminal apparatus under a condition in which said second terminal apparatus permits to provide said terminal state information to said first terminal apparatus.
